(19) United States
(12) Patent Application Publication
(10) Pub. No.: US 2023/0202077 A1
(43) Pub. Date: Jun. 29, 2023

(54) DEVICE FOR PRODUCING PLASTIC BODIES

(71) Applicant: Charles Andrew Lowry, Riverton, UT (US)

(72) Inventor: Charles Andrew Lowry, Riverton, UT (US)

(21) Appl. No.: 17/974,206

(22) Filed: Oct. 26, 2022

Related U.S. Application Data
(60) Provisional application No. 63/293,090, filed on Dec. 23, 2021.

(51) Int. Cl. B29C 35/08; B29C 39/26

(52) U.S. Cl. CPC B29C 35/08; B29C 39/26

(57) ABSTRACT

The device relates to a device for producing plastic bodies wherein the device comprises a photopolymer curing unit comprising at least one radiation source with a selected radiation spectrum or spectrums for curing of light hardening photopolymer, a mold which mold is partially or wholly comprised of light transmissive material which material allows the passage of radiation of selected spectrum or spectrums for curing of light hardening photopolymers, and a fixture for securing and rotating the mold along one or more axis.

Light hardening photopolymer is introduced into the cavity of the mold and exposed to a selected radiation spectrum or spectrums for curing of light hardening photopolymers through the mold light transmissive material thereby hardening and curing the light hardening photopolymer whereupon the cured light hardening photopolymer is removed from the mold and the process repeated.

The device permits the production of photopolymer molded bodies or photopolymer coated bodies in a continuous or discontinuous process.

This patent application claims the benefits of U.S. Provisional Patent Application No. 63/293,090, Filed: 23 Dec. 2021, which is incorporated by reference herein in its entirety.

### FIELD OF THE DEVICE

The device generally relates to a device for producing plastic bodies, and more specifically, to a device for producing a plastic body or bodies by the process of exposing light hardening photopolymer within a mold cavity constructed in part or wholly of a light transmissive material to at least one radiation source with a selected radiation spectrum or spectrums for curing of light hardening photopolymer.

### BACKGROUND OF THE DEVICE

Historically plastic bodies have been produced through the use of plastic injection molding wherein a thermoplastic is melted and forced under great pressure into a steel mold wherein this steel mold is used to shape and cool the molten plastic thereby forming a plastic body (plastic injection molding), or the thermoplastic is deposited into a metal mold whereupon the metal mold is heated to such a temperature to melt the plastic within and subsequently and rotated to distribute the molten plastic within the metal mold. The metal mold is then cooled and the plastic body is removed (rotomolding).

Numerous patents have been produced based on one of these methods, such as: U.S. Pat. No. 3,048,896, Marlo, Filed May 26, 1959, “CENTRFUGAL ROTATIONAL MOLDING METHOD” wherein is disclosed “This invention relates in general to a centrifugal rotational molding method, and more particularly to a method for producing hollow articles from a thermo-setting plastic. . . . the mold is subjected to heat as by insertion into the Oven 17 in order to raise the temperature of the thermosetting plastic and commence the curing process.” “it may be necessary to heat the plastic to a temperature between 350 F. and 700 F. in order for it to properly set and cure.”

This Patent does not disclose the use of a photopolymer curing unit comprising at least one radiation source with a selected radiation spectrum or spectrums for curing of light hardening photopolymer, a mold which mold is partially or wholly comprised of light transmissive material which material allows the passage of radiation of selected spectrum or spectrums for curing of light hardening photopolymers, nor a fixture for securing and rotating the mold along one or more axis.

U.S. Pat. No. 3,341,641, Spencer, Filed Sep. 12, 1967, “CENTRFUGAL CASTING PROCESS” wherein is disclosed “This invention relates to a centrifugal casting process, more particularly to a centrifugal casting process wherein the rotation rate of the mold is varied.” and a “centrifugal casting process”. This Patent does not disclose the use of a photopolymer curing unit comprising at least one radiation source with a selected radiation spectrum or spectrums for curing of light hardening photopolymer, a mold which mold is partially or wholly comprised of light transmissive material which material allows the passage of radiation of selected spectrum or spectrums for curing of light hardening photopolymers, nor a fixture for securing and rotating the mold along one or more axis.

U.S. Pat. No. 4,285,903, Lemelson, Filed Aug. 25, 1981, “MOLDING SYSTEM” wherein is disclosed “a fast setting resin . . . of the type manufactured by the Dow Chemical Company of Midland, Mich. which molding materials are mixed from a resin, a catalyst and a modifier”.

This Patent does not disclose the use of a photopolymer curing unit comprising at least one radiation source with a selected radiation spectrum or spectrums for curing of light hardening photopolymer, a mold which mold is partially or wholly comprised of light transmissive material which material allows the passage of radiation of selected spectrum or spectrums for curing of light hardening photopolymers, nor a fixture for securing and rotating the mold along one or more axis.

US Patent US 20140277664A1, Stump, Filed Sep. 18, 2014, “3D PRINTING SYSTEMS AND METHODS FOR FABRICATING INJECTION MOLDS” wherein is disclosed an “inverse computer aided design (“CAD) file may be generated based upon a visualization file that represents a 3D object. The inverse CAD file can then be altered based upon various parameters associated with the 3D object. One or more injection molds can be fabricated using a 3D printer based on the altered inverse CAD file.”

This Patent does not disclose the use of a photopolymer curing unit comprising at least one radiation source with a selected radiation spectrum or spectrums for curing of light hardening photopolymer, a mold which mold is partially or wholly comprised of light transmissive material which material allows the passage of radiation of selected spectrum or spectrums for curing of light hardening photopolymers, nor a fixture for securing and rotating the mold along one or more axis.

U.S. Pat. No. 5,164,128, Modrek et al., Filed Nov. 17, 1992, “METHODS FOR CURING PARTIALLY POLYMERIZED PARTS” wherein is disclosed “An improved stereolithography system and method for curing a stereolithography-produced part, including at least some material that is no more than partially transformed, by exposing the part to off-peak absorptive wavelengths of synergistic stimulation to achieve a more uniform cure.”

This Patent does not disclose the use of a photopolymer curing unit comprising at least one radiation source with a selected radiation spectrum or spectrums for curing of light hardening photopolymer, a mold which mold is partially or wholly comprised of light transmissive material which material allows the passage of radiation of selected spectrum or spectrums for curing of light hardening photopolymers, nor a fixture for securing and rotating the mold along one or more axis.

All these method has been effective in producing molded plastic bodies but it is very expensive to setup and run. The expenses involved are, among many things, producing the metal mold (often on the order of tens of thousands of dollars), procuring a thermoplastic injection molding machine or rotomolding device (also often on the order of tens of thousands of dollars), heating the plastic to its melting point, and cooling the plastic body after the formation of the plastic body. Therefore due to these and other factors, producing a run of plastic bodies may prove to be too costly thereby making the production of plastic bodies economically unfeasible.

None of these methods disclose the use of a photopolymer curing unit comprising at least one radiation source with a selected radiation spectrum or spectrums for curing of light hardening photopolymer, a mold which mold is partially or wholly comprised of light transmissive material which material allows the passage of radiation of selected spectrum or spectrums for curing of light hardening photopolymers, nor a fixture for securing and rotating the mold along one or more axis.

### SUMMARY OF THE DEVICE

The heretofore unfulfilled requirement for a means of producing plastic in molded bodies economically and inexpensively is herein fulfilled through the device.

The technology surrounding the manufacture and chemistry of photopolymer resin is well known and understood and not part of the device.

What is new and improved in the device is the use of at least one radiation source with selected radiation spectrum or spectrums for curing of light hardening photopolymers in combination with at least one plastic mold manufactured in part or wholly from light transmissive materials which allows the transmission of one or more selected light spectrums for curing of light hardening photopolymers.

To effect the manufacture of a plastic body, light hardening photopolymer or photopolymers are deposited within the mold cavity and the mold cavity is subsequently exposed to selected radiation spectrum or spectrums for curing of light hardening photopolymers which radiation travels from a place without the mold cavity to a place within the mold cavity, which radiation causes the curing of the light hardening photopolymer or polymers within the mold cavity which curing produces a plastic body within the mold cavity to a shape as determined by the mold cavity.

In particular the mold will allow the transmission of select spectrum of, for example, light between 200 nanometers and 780 nanometers, from a location outside the mold cavity through the surface of the mold cavity into the mold cavity so as to affect the curing of the photopolymer within the mold cavity. It is anticipated that other frequencies such as but not limited to microwave and far infrared could also be utilized to cure light hardening resins, and therefore other frequencies of light are allowed and within the scope of the device. The mold is made out of light transmissive materials which allows the transmission of one or more selected light spectrums for curing of light hardening photopolymers such as but not limited to Polylactide and Polyethylene terephthalate glycol.

Additionally the device incorporates mounting the mold or molds to a fixture capable of rotating the mold along one or more axis to allow a more even distribution of light curing photopolymer within the mold cavity and providing the capability of more even illumination of the light curing photopolymer within the mold cavity. This allows an affordable repeatable means of molding plastic bodies.

Numerous benefits accrue from manufacturing parts of the mold and mold cavity from light transmissive material such as but not limited to Polylactide and Polyethylene terephthalate glycol such as the cost savings of manufacturing the mold from light transmissive material such as but not limited to Polylactide and Polyethylene terephthalate glycol, and the much reduced time required to produce a mold manufactured from such materials as compared to traditional metal.

Additionally a mold partially or wholly manufactured from light transmissive materials such as but not limited to Polylactide and Polyethylene terephthalate glycol are ideal for use in producing plastic bodies using light hardening photopolymers due to these plastics properties of natural lubricity, durability, ease of mold manufacture, and speed of mold manufacture.

The device therefore provides a means for producing plastic bodies for curing light hardening photopolymers, comprising:
at least one radiation source which produces radiation of the proper spectral frequency or frequencies to effect hardening of the light hardening photopolymer or photopolymers,
at least one mold constructed in part or wholly of light transmissive material which allows the transmission of proper spectral frequency or frequencies to effect hardening of the light hardening photopolymer or photopolymers,
at least one containing at least one mold cavity for receiving at least one light hardening photopolymer,
at least one fixture for mounting the mold or molds wherein the fixture may be rotated about one or more rotating axis.

The mold of the current device contains at least one mold cavity wherein the mold cavity wall is composed of light transmissive material. The mold itself may be comprised entirely of one or more light transmissive material or may be comprised of many assorted elements such as other types of plastics or metals which facilitate to support the light transmissive material mold.

For example, a typical mold may be entirely constructed of Polylactide or Polyethylene terephthalate glycol or other such light transmissive material.

Alternately, a mold may be constructed with external structures using Polyether Ether Ketone, steel, brass, or other assorted materials so as to facilitate the mounting and operation of the light transmissive material mold.

Alternately, a mold may be constructed with external structures constructed of other light transmissive material or materials which act as a light pipe to direct the light to cavity within the light transmissive material mold.

The construction and design of molds utilizing different elements is well understood and not within the scope of this device.

The photopolymer curing unit of the device is distinguished by the use of a mold or molds which contains at least one cavity comprising a mold wall constructed of light transmissive material for the receiving of light hardening photopolymer or photopolymers, and at least one radiation source with a selected radiation spectrum or spectrums for curing of the photopolymer or photopolymers.

Additionally, the mold mounts to a fixture which fixture rotates about one or more axis so as to effect a more even illumination of mold cavity. An additional benefit to rotating the fixture about the fixture axis is facilitating an even and uniform deposition of the light hardening photopolymer.

Furthermore, the photopolymer curing unit of the device may also include the possibility that the location of the mold cavity may be varying relative to the light source, so that illumination of the light curing photopolymer within the mold cavity may be varied by a specific change of direction of the radiation source relative to the mold cavity. For example, a radiation source can be moved back and forth in front of and about the mold cavity, the mold can be moved with respect to the light source, or both can be moved with respect to each other so as to effect sweeping of the light completely or partially over the mold cavity so to aid in completely and uniformly illuminating the mold cavity to effect a more even curing of the photopolymer within the mold cavity.

### BRIEF DESCRIPTION OF THE DRAWINGS

FIG. 1 depicts the device (10) consisting of the radiation source or sources (20) placed in such a way that the mold cavity (40) can be exposed to the illumination emanating from the radiation source or sources (20) located without the light transmissive material mold (30) to a location within mold cavity (40) through mold cavity wall (45). Additionally fixture (50) may be rotated about one fixture axis (70) so as to effect a more even illumination of mold cavity (45). An additional benefit to rotating fixture (50) about fixture axis (70) is facilitating an even and uniform deposition of the light hardening photopolymer.

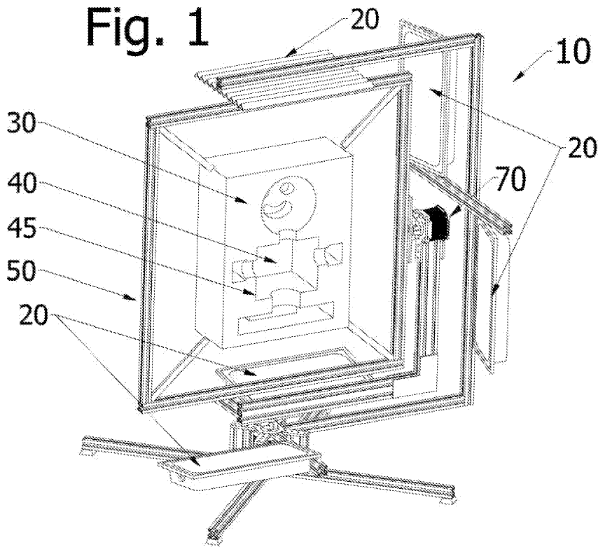

FIG. 2 depicts the device (10) consisting of the radiation source or sources (20) placed in such a way that the mold cavity (40) can be exposed to the illumination emanating from the radiation source or sources (20) located without the light transmissive material mold (30) to a location within mold cavity (40) through mold cavity wall (45). Less exposed areas may be more sufficiently irradiated by mounting mold (30) into fixture (50) and rotating fixture (50) about fixture axis (70) so as to effect a more even illumination of mold cavity (45). An additional benefit to rotating fixture (50) about fixture axis (70) is facilitating an even and uniform deposition of the light hardening photopolymer.

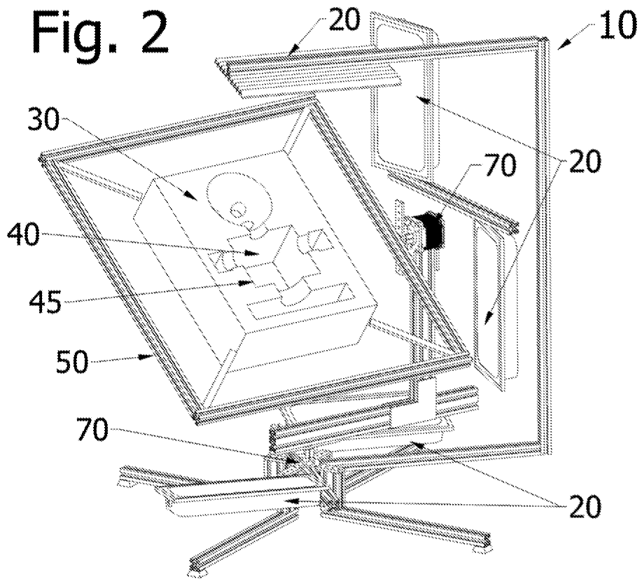

FIG. 3 depicts the light transmissive material mold (30) consisting of the radiation source or sources (20) placed within the mold in such a way that the mold cavity (40) can be exposed to the illumination emanating from the radiation source or sources (20) located within the light transmissive material mold (30) to a location within mold cavity (40) through mold cavity wall (45).

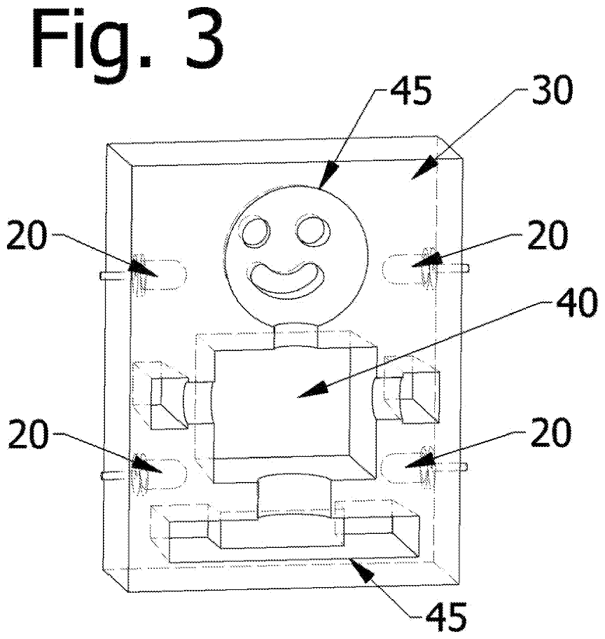

FIG. 4 depicts the light transmissive material mold (30), consist of a mold cavity (40), mold cavity wall (45), mold support structures (47) and light transmissive material or materials (48).

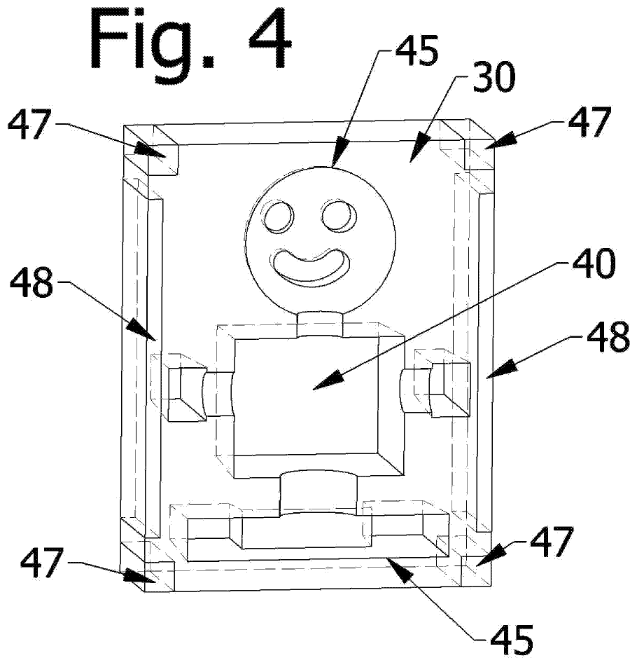

FIG. 5 depicts the device (10) consisting of the radiation source or sources (20) mounted to fixture (50) in such a way that the mold cavity (40) can be exposed to the illumination emanating from the radiation source or sources (20) located without the light transmissive material mold (30) to a location within mold cavity (40) through mold cavity wall (45). Less exposed areas may be more sufficiently irradiated by mounting mold (30) into fixture (50) and rotating fixture (50) about fixture axis (70) so as to effect a more even illumination of mold cavity (45). An additional benefit to rotating fixture (50) about fixture axis (70) is facilitating an even and uniform deposition of the light hardening photopolymer.

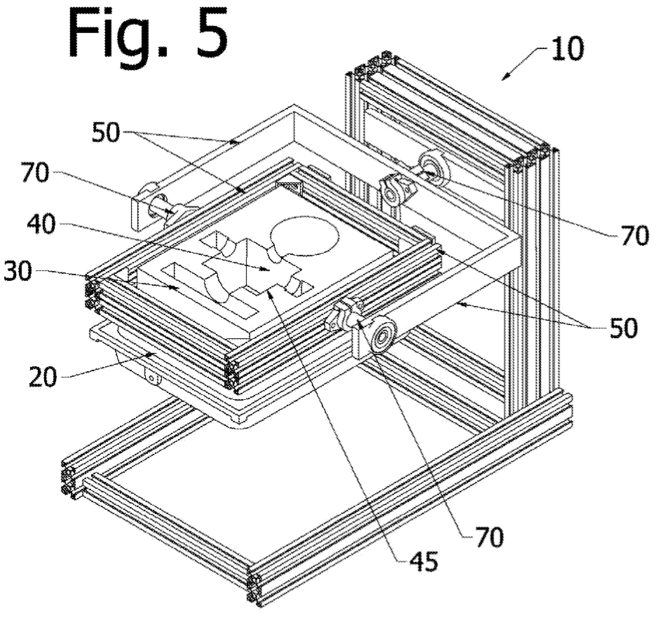

The embodiments and examples described only serve for explaining the device; however, they are not supposed nor intended to limit the spirit and scope of the device.

The invention claimed is:

1. A method for creating three dimensional plastic bodies comprising the steps of dispensing at least one light hardening photopolymer into a mold cavity of a mold which mold is constructed of material which allows the passage of light with the proper spectral frequency or frequencies to effect hardening of light hardening photopolymers with said mold being placed within a fixture designed for receiving said mold and subsequently exposing the mold to radiation of the proper spectral frequency or frequencies to effect hardening of the light hardening photopolymer or photopolymers within the mold cavity which radiation of the proper spectral frequency or frequencies to effect hardening of light hardening photopolymer or photopolymers is emitted by at least one radiation source which produces radiation of the proper spectral frequency or frequencies to effect hardening of the light hardening photopolymer or photopolymers,

2. The method of claim 1, wherein the radiation source may be located external to the mold and the mold cavity,

3. The method of claim 1 wherein the radiation source may be located internal to the mold and external to the mold cavity,

4. The method of claim 1 wherein the mold is mounted to a fixture for mounting said mold such that said mold may be rotated about one or more axis,

5. The method of claim 4, wherein the mold may be constructed with support structures using Polyether Ether Ketone, steel, brass, or other assorted materials so as to facilitate the mounting and operation of the mold.
